(19) United States
(12) Patent Application Publication
(10) Pub. No.: US 2019/0061742 A1
(43) Pub. Date: Feb. 28, 2019

(54) DRIVING SUPPORT DEVICE AND DRIVING SUPPORT METHOD

(71) Applicant: DENSO TEN Limited, Kobe-shi (JP)

(72) Inventors: Tatsuki KUBO, Kobe-shi (JP); Tamaki TAKEUCHI, Kobe-shi (JP)

(73) Assignee: DENSO TEN Limited, Kobe-shi (JP)

(21) Appl. No.: 16/041,599

(22) Filed: Jul. 20, 2018

(30) Foreign Application Priority Data
Aug. 31, 2017 (JP) 2017-167373

(51) Int. Cl. B60W 30/09; B60W 30/095

(52) U.S. Cl. CPC B60W 30/09; B60W 50/0097; B60W 30/095

(57) ABSTRACT

A driving support device includes an estimation portion which estimates an anticipated course of the present vehicle and an image generation portion which generates an image around the present vehicle including a graphic. The graphic at least indicates, in a vehicle width direction of the anticipated course, part of an edge of a region occupied by an obstacle candidate object that is present in a direction in which the present vehicle travels.

This nonprovisional application claims priority under 35 U.S.C. § 119(a) on Patent Application No. 2017-167373 filed in Japan on Aug. 31, 2017, the entire contents of which are hereby incorporated by reference.

### BACKGROUND OF THE INVENTION

### Field of the Invention

The present invention relates to driving support technologies.

### Description of the Related Art

A vehicle display device which facilitates traveling while an obstacle or the like is being passed is disclosed in Japanese Unexamined Patent Application Publication No. 11-259798.

The vehicle display device disclosed in Japanese Unexamined Patent Application Publication No. 11-259798 calculates a predicted travel track of the present vehicle, measures a distance between an obstacle or the like and the center of the present vehicle in a lateral direction and calculates/displays, from the measured distance in the lateral direction and the width of the present vehicle, a margin distance in the lateral direction. Furthermore, the vehicle display device disclosed in Japanese Unexamined Patent Application Publication No. 11-259798 calculates an arrival time or a distance up to the obstacle or the like, and when the arrival time or the distance up to the obstacle or the like is shorter than a predetermined value and the margin distance in the lateral direction is shorter than a predetermined value, the vehicle display device uses a sound or a warning sound so as to encourage a user to pay attention.

In the vehicle display device disclosed in Japanese Unexamined Patent Application Publication No. 11-259798, since the margin distance in the lateral direction is displayed as a value, it is impossible to make a driver intuitively grasp a position relationship between the present vehicle and the obstacle or the like in the lateral direction (vehicle width direction). Hence, it is hard to say that the vehicle display device disclosed in Japanese Unexamined Patent Application Publication No. 11-259798 sufficiently facilitates traveling while an obstacle or the like is being passed.

### SUMMARY OF THE INVENTION

An object of the present invention is to provide a driving support technology with which it is possible to make a driver intuitively grasp a position relationship between the present vehicle and an obstacle candidate object in a vehicle width direction.

According to one aspect of the present invention, a driving support device includes: an estimation portion which estimates an anticipated course of the present vehicle; and an image generation portion which generates an image around the present vehicle including a graphic, where the graphic at least indicates, in a vehicle width direction of the anticipated course, part of an edge of a region occupied by an obstacle candidate object that is present in a direction in which the present vehicle travels.

According to another aspect of the present invention, a driving support method includes: an estimation step of estimating an anticipated course of the present vehicle; and an image generation step of generating an image around the present vehicle including a graphic, where the graphic at least indicates, in a vehicle width direction of the anticipated course, part of an edge of a region occupied by an obstacle candidate object that is present in a direction in which the present vehicle travels.

### BRIEF DESCRIPTION OF THE DRAWINGS

FIG. 1 is a diagram showing the configuration of a driving support device according to a first embodiment;

FIG. 2 is a diagram illustrating positions in which four vehicle-mounted cameras are arranged in a vehicle;

FIG. 3 is a diagram showing an example of a virtual projection plane;

FIG. 4 is a flowchart showing an example of the operation of the driving support device according to the first embodiment;

FIG. 5 is a diagram showing an example of an output image;

FIG. 6 is a diagram showing an example of the output image;

FIG. 7 is a diagram showing an example of the output image;

FIG. 8 is a diagram showing the configuration of a driving support device according to a second embodiment;

FIG. 9 is a diagram showing an example of a relationship between the speed of the present vehicle and a predetermined value;

FIG. 10 is a diagram showing an example of the relationship between the speed of the present vehicle and the predetermined value;

FIG. 11 is a flowchart showing an example of the operation of the driving support device according to the second embodiment;

FIG. 12 is a diagram showing the configuration of a driving support device according to a third embodiment;

FIG. 13 is a flowchart showing an example of the operation of the driving support device according to the third embodiment;

FIG. 14 is a diagram showing an example of an output image;

FIG. 15 is a diagram showing an example of the output image;

FIG. 16 is a diagram showing an example of the output image;

FIG. 17 is a diagram showing the configuration of a driving support device according to a fourth embodiment;

FIG. 18 is a flowchart showing an example of the operation of the driving support device according to the fourth embodiment;

FIG. 19 is a diagram showing an example of an output image; and

FIG. 20 is a diagram showing an example of the output image.

### DESCRIPTION OF THE PREFERRED EMBODIMENTS

Illustrative embodiments of the present invention will be described in detail below with reference to drawings.

### 1. First Embodiment

<1-1. Configuration of Driving Support Device According to First Embodiment>

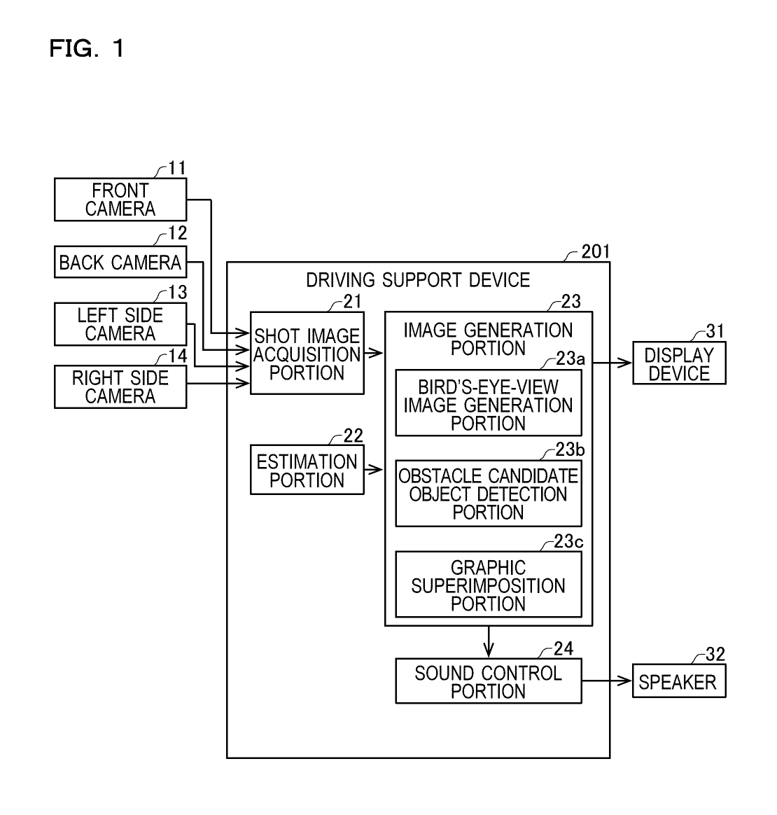

FIG. 1 is a diagram showing the configuration of a driving support device 201 according to the present embodiment. The driving support device 201 is mounted in a vehicle such as an automobile. In the following description, the vehicle in which the driving support device 201 or driving support devices according to the other embodiments described later are mounted is referred to as the “present vehicle”. A direction which is a linear travel direction of the present vehicle and which extends from a driver seat toward a steering is referred to as a “forward direction”. A direction which is a linear travel direction of the present vehicle and which extends from the steering toward the driver seat is referred to as a “backward direction”. A direction which is perpendicular to the linear travel direction of the present vehicle and a vertical line and which extends from the right side to the left side of a driver who faces in the forward direction is referred to as a “leftward direction”. A direction which is perpendicular to the linear travel direction of the present vehicle and the vertical line and which extends from the left side to the right side of the driver who faces in the forward direction is referred to as a “rightward direction”.

A front camera 11, a back camera 12, a left side camera 13, a right side camera 14, the driving support device 201, a display device 31 and a speaker 32 shown in FIG. 1 are mounted in the present vehicle.

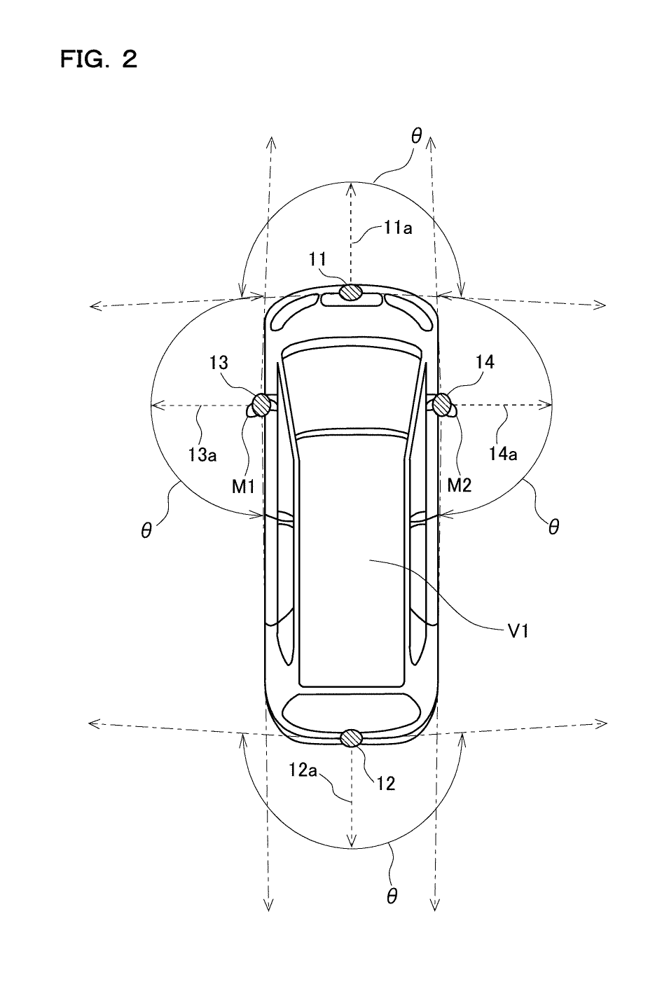

FIG. 2 is a diagram illustrating positions in which the four vehicle-mounted cameras (the front camera 11, the back camera 12, the left side camera 13 and the right side camera 14) are arranged in the present vehicle V1.

The front camera 11 is provided at the front end of the present vehicle V1. The optical axis 11a of the front camera 11 is along the forward/backward direction of the present vehicle V1 in plan view from above. The front camera 11 shoots in the forward direction of the present vehicle V1. The back camera 12 is provided at the back end of the present vehicle V1. The optical axis 12a of the back camera 12 is along the forward/backward direction of the present vehicle V1 in plan view from above. The back camera 12 shoots in the backward direction of the present vehicle V1. Although the positions in which the front camera 11 and the back camera 12 are attached are preferably in the center of the present vehicle V1 in a left/right direction, the positions may be slightly displaced from the center in the left/right direction toward the left/right direction.

The left side camera 13 is provided in the left-side door mirror M1 of the present vehicle V1. The optical axis 13a of the left side camera 13 is along the left/right direction of the present vehicle V1 in plan view from above. The left side camera 13 shoots in the leftward direction of the present vehicle V1. The right side camera 14 is provided in the right-side door mirror M2 of the present vehicle V1. The optical axis 14a of the right side camera 14 is along the left/right direction of the present vehicle V1 in plan view from above. The right side camera 14 shoots in the rightward direction of the present vehicle V1. When the present vehicle V1 is a so-called door mirrorless vehicle, the left side camera 13 is attached around the rotary shaft (hinge portion) of a left side door without intervention of the door mirror, and the right side camera 14 is attached around the rotary shaft (hinge portion) of a right side door without intervention of the door mirror.

The angle of view θ of each of the vehicle-mounted cameras in a horizontal direction is equal to or more than 180 degrees. Thus, it is possible to shoot all around the present vehicle V1 in the horizontal direction with the four vehicle-mounted cameras (the front camera 11, the back camera 12, the left side camera 13 and the right side camera 14). Although in the present embodiment, the number of vehicle-mounted cameras is set to four, the number of vehicle-mounted cameras necessary for producing a bird's-eye-view image described later with images shot by the vehicle-mounted cameras is not limited to four as long as a plurality of cameras are used. As an example, when the angle of view θ of each of the vehicle-mounted cameras in the horizontal direction is relatively wide, based on three shot images acquired from three cameras which are less than four cameras, a bird's-eye-view image may be generated. Furthermore, as another example, when the angle of view θ of each of the vehicle-mounted cameras in the horizontal direction is relatively narrow, based on five shot images acquired from five cameras which are more than four cameras, a bird's-eye-view image may be generated.

With reference back to FIG. 1, the four vehicle-mounted cameras (the front camera 11, the back camera 12, the left side camera 13 and the right side camera 14) output the shot images to the driving support device 201.

The driving support device 201 processes the shot images output from the four vehicle-mounted cameras (the front camera 11, the back camera 12, the left side camera 13 and the right side camera 14), and outputs the processed images to the display device 31. The driving support device 201 performs control so as to output a sound from the speaker 32.

The display device 31 is provided in such a position that the driver of the present vehicle can visually recognize the display screen of the display device 31, and displays the images output from the driving support device 201. Examples of the display device 31 include a display installed in a center console, a meter display installed in a position opposite the driver seat and a head-up display which projects an image on a windshield.

The speaker 32 outputs the sound according to the control of the driving support device 201.

The driving support device 201 can be formed with hardware such as an ASIC (application specific integrated circuit) or an FPGA (field-programmable gate array) or with a combination of hardware and software. When the driving support device 201 is formed with software, a block diagram of a portion realized by the software indicates a functional block diagram of the portion. A function realized with the software is described as a program, and the program is executed on a program execution device, with the result that the function may be realized. As the program execution device, for example, a computer which includes a CPU (Central Processing Unit), a RAM (Random Access Memory) and a ROM (Read Only Memory) can be mentioned.

The driving support device 201 includes a shot image acquisition portion 21, an estimation portion 22, an image generation portion 23 and a sound control portion 24.

The shot image acquisition portion 21 acquires, from the four vehicle-mounted cameras (the front camera 11, the back camera 12, the left side camera 13 and the right side camera 14), analogue or digital shot images at a predetermined period (for example, a period of 1/30 seconds) continuously in time. Then, when the acquired shot images are analogue, the shot image acquisition portion 21 converts (A/D conversion) the analogue shot images into digital shot images. The shot image acquisition portion 21 outputs the acquired shot images or the shot images acquired and converted to the image generation portion 23.

The estimation portion 22 acquires the steering angle information, the vehicle speed information and the like of the present vehicle from the vehicle control ECU (Electronic Control Unit) and the like of the present vehicle, estimates an anticipated course of the present vehicle based on the acquired information and outputs the estimation result to the image generation portion 23.

The image generation portion 23 includes a bird's-eye-view image generation portion 23a, an obstacle candidate object detection portion 23b and a graphic superimposition portion 23c.

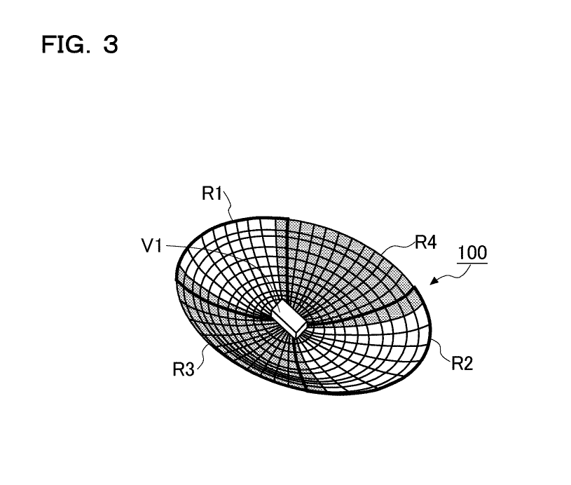

The bird's-eye-view image generation portion 23a projects the shot images acquired by the shot image acquisition portion 21 on a virtual projection plane, and converts them into projection images. Specifically, the bird's-eye-view image generation portion 23a projects the shot image of the front camera 11 on the first region R1 of the virtual projection plane 100 in a virtual three-dimensional space shown in FIG. 3, and converts the shot image of the front camera 11 into a first projection image. Likewise, the bird's-eye-view image generation portion 23a respectively projects the shot image of the back camera 12, the shot image of the left side camera 13 and the shot image of the right side camera 14 on the second to fourth regions R2 to R4 of the virtual projection plane 100 shown in FIG. 3, and respectively converts the shot image of the back camera 12, the shot image of the left side camera 13 and the shot image of the right side camera 14 into second to fourth projection images.

The virtual projection plane 100 shown in FIG. 3 has, for example, a substantially hemispherical shape (bowl shape). The center portion (the bottom portion of the bowl) of the virtual projection plane 100 is determined to be a position in which the present vehicle V1 is present. The virtual projection plane 100 is made to include the curved plane as described above, and thus it is possible to reduce the distortion of a picture of an object which is present in a position away from the present vehicle V1. Each of the first to fourth regions R1 to R4 includes portions which overlap the other adjacent regions. The overlapping portions as described above are provided, and thus it is possible to prevent the picture of the object projected on the boundary portion of the regions from disappearing.

The bird's-eye-view image generation portion 23a generates, based on a plurality of projection images, a virtual viewpoint image seen from a virtual viewpoint. Specifically, the bird's-eye-view image generation portion 23a virtually adheres the first to fourth projection images to the first to fourth regions R1 to R4 in the virtual projection plane 100.

The bird's-eye-view image generation portion 23a virtually configures a polygon model showing the three-dimensional shape of the present vehicle V1. The model of the present vehicle V1 is arranged, in the virtual three-dimensional space where the virtual projection plane 100 is set, in the position (the center portion of the virtual projection plane 100) which is determined to be the position where the present vehicle V1 is present such that the first region R1 is the front side and the fourth region R4 is the back side.

Furthermore, the bird's-eye-view image generation portion 23a sets the virtual viewpoint in the virtual three-dimensional space where the virtual projection plane 100 is set. The virtual viewpoint is specified by a viewpoint position and a view direction. As long as at least part of the virtual projection plane 100 enters the view, the viewpoint position and the view direction of the virtual viewpoint can be set to an arbitrary viewpoint position and an arbitrary view direction. In the present embodiment, the viewpoint position of the virtual viewpoint is assumed to be located backward and upward of the present vehicle, and the view direction of the virtual viewpoint is assumed to be located forward and downward of the present vehicle. In this way, the virtual viewpoint image generated by the bird's-eye-view image generation portion 23a becomes a bird's-eye-view image. The viewpoint position of the virtual viewpoint is assumed to be located backward and upward of the present vehicle, the view direction of the virtual viewpoint is assumed to be located forward and downward of the present vehicle and thus the driver can more accurately confirm a distant obstacle candidate object. Unlike the present embodiment, for example, the viewpoint position may be assumed to be the position of the eyes of a standard driver, and the view direction may be assumed to be located forward of the present vehicle.

The bird's-eye-view image generation portion 23a virtually cuts out, according to the set virtual viewpoint, the image of a region (region seen from the virtual viewpoint) necessary for the virtual projection plane 100. The bird's-eye-view image generation portion 23a also performs, according to the set virtual viewpoint, rendering on the polygon model so as to generate a rendering picture of the present vehicle V1. Then, the bird's-eye-view image generation portion 23a generates a bird's-eye-view image in which the rendering picture of the present vehicle V1 is superimposed on the image that is cut out.

The obstacle candidate object detection portion 23b detects, based on the shot image of the front camera 11, an obstacle candidate object which can be present in the forward direction of the present vehicle. In the detection of the obstacle candidate object, a known image recognition technology is used. For example, in the detection of an obstacle candidate object which is a moving object, a background differencing method can be used, and in the detection of an obstacle candidate object which is a stationary object, a mobile stereo method can be used. Although in the present embodiment, the image recognition technology is used so as to detect the obstacle candidate object, in addition to or instead of the image recognition technology, for example, information which is output from a radar device mounted in the present vehicle or information which can be obtained by communication with a cloud center, vehicle-to-vehicle communication, road-to-vehicle communication or the like may be used so as to detect the obstacle candidate object.

The graphic superimposition portion 23c calculates a vehicle width direction of the anticipated course estimated by the estimation portion 22, and generates a graphic indicating part of an edge of a region occupied by the obstacle candidate object in the calculated vehicle width direction. Specifically, the graphic superimposition portion 23c calculates the vehicle width direction of the anticipated course estimated by the estimation portion 22, and generates the graphic indicating an overlapping region of the region occupied by the present vehicle and a region occupied by the obstacle candidate object in the calculated vehicle width direction. The graphic superimposition portion 23c generates an output image obtained by superimposing the graphic described above on the bird's-eye-view image generated by the bird's-eye-view image generation portion 23a. The output image generated by the graphic superimposition portion 23c is output to the display device 31. The vehicle width direction of the anticipated course estimated by the estimation portion 22 is a direction which is substantially perpendicular to the anticipated course, and for example, when the anticipated course is a course in which the present vehicle travels linearly forward, the vehicle width direction coincides with a vehicle width direction in the current position of the present vehicle.

The sound control portion 24 makes the speaker 32 produce, for example, a caution sound which provides a notification that the obstacle candidate object is detected and a warning sound which provides a notification that an overlapping region is produced. The warning sound is preferably set more stimulative than the caution sound.

<1-2. Operation of Driving Support Device According to First Embodiment>

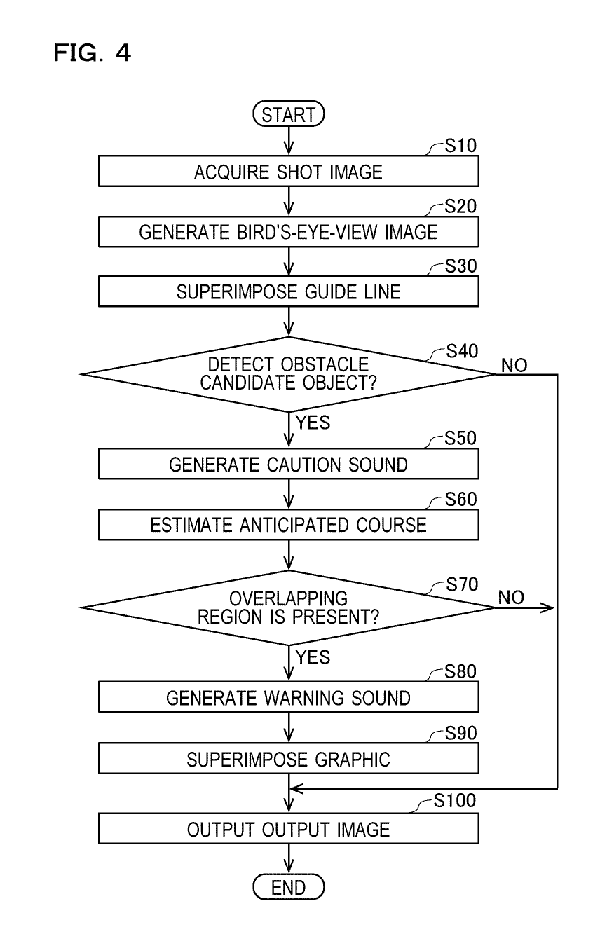

FIG. 4 is a flowchart showing an example of the operation of the driving support device 201. The driving support device 201 periodically performs a flow operation shown in FIG. 4.

When the flow operation shown in FIG. 4 is started, the shot image acquisition portion 21 first acquires the shot images from the four vehicle-mounted cameras (the front camera 11, the back camera 12, the left side camera 13 and the right side camera 14) (step S10).

Then, the bird's-eye-view image generation portion 23a uses the shot images acquired by the shot image acquisition portion 21 so as to generate the bird's-eye-view image (step S20).

Then, the image generation portion 23 uses the image recognition technology so as to detect the position of a roadway, calculates a travelable region of the present vehicle based on the detected position of the roadway and superimposes a left side guide line indicating the left end of the travelable region and a right side guide line indicating the right end of the travelable region on the bird's-eye-view image (step S30).

Then, the image generation portion 23 determines whether or not the obstacle candidate object is detected by the obstacle candidate object detection portion 23b (step S40).

When the obstacle candidate object is not detected, for example, the image generation portion 23 outputs, as the output image, to the display device 31, a bird's-eye-view image obtained by superimposing a rendering picture VR1 of the present vehicle and the left side guide line G1 and the right side guide line G2 as shown in FIG. 5 (step S100), and the flow operation is completed. Although the form of the left side guide line G1 and the right side guide line G2 included in the output image shown in FIG. 5 is not particularly limited, for example, green lines are preferably used.

On the other hand, when the obstacle candidate object is detected, the sound control portion 24 makes the speaker 32 produce the caution sound according to the result of the detection by the obstacle candidate object detection portion 23b (step S50).

In step S60 subsequent to step S50, the estimation portion 22 estimates the anticipated course of the present vehicle.

In step S70 subsequent to step S60, the graphic superimposition portion 23c calculates the vehicle width direction of the anticipated course estimated by the estimation portion 22 so as to determine whether or not an overlapping region of the region occupied by the present vehicle and the region occupied by the obstacle candidate object is present in the calculated vehicle width direction.

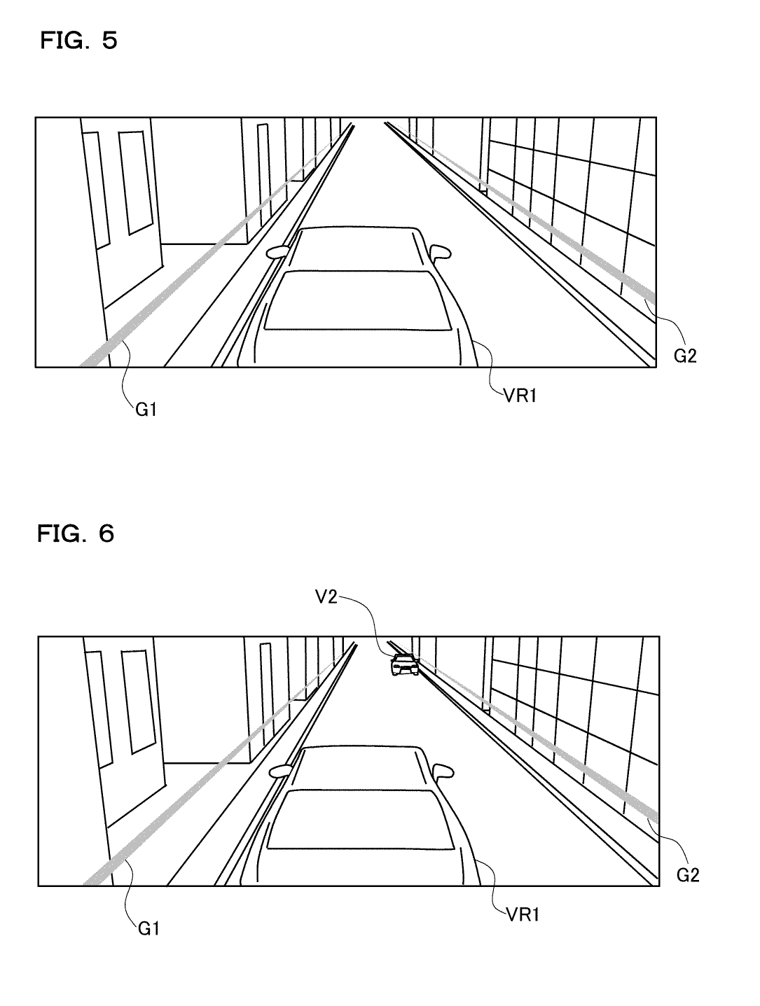

When the overlapping region is not present, the image generation portion 23 outputs, as the output image, to the display device 31, for example, a bird's-eye-view image obtained by superimposing the rendering picture VR1 of the present vehicle and the left side guide line G1 and the right side guide line G2 as shown in FIG. 6 (step S100), and the flow operation is completed. A picture of an oncoming vehicle V2 which is the obstacle candidate object is included in the output image shown in FIG. 6.

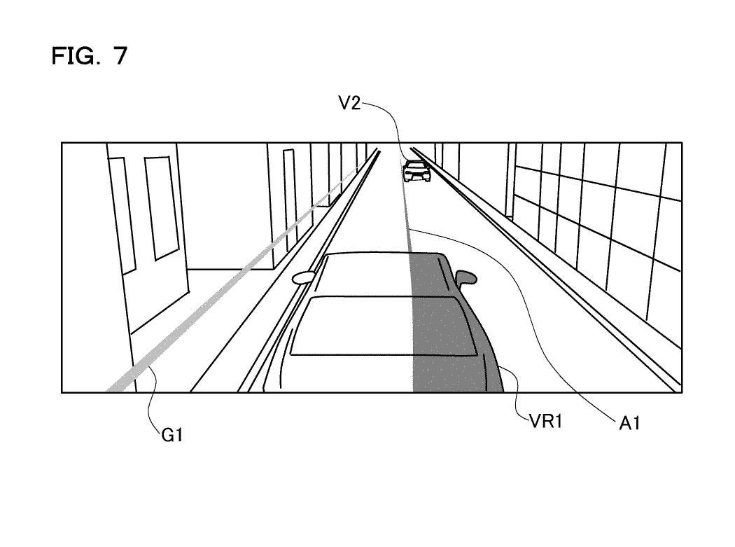

When the overlapping region is present, the graphic superimposition portion 23c generates a warning line serving as a graphic which indicates a boundary between the overlapping region and the non-overlapping region, and superimposes, instead of the right side guide line, the warning line on the bird's-eye-view image (step S90), furthermore, the image generation portion 23 uses a different color for the overlapping region in the rendering picture VR1 of the present vehicle from the regions other than the overlapping region, for example, a bird's-eye-view image obtained by superimposing the rendering picture VR1 of the present vehicle and the left side guide line G1 and the warning line A1 as shown in FIG. 7 is output as the output image to the display device 31 (step S100) and the flow operation is completed.

The driver confirms the output image including the graphic indicating the overlapping region, and thereby can intuitively grasp a position relationship between the present vehicle and the obstacle candidate object in the vehicle width direction. In this way, it is easy to drive while avoiding future contact between the present vehicle and the obstacle candidate object.

The rendering picture VR1 of the present vehicle is made to differ in form between the overlapping region and the non-overlapping region, and thus the driver can grasp the width of the overlapping region. In this way, it is easier to drive while avoiding future contact between the present vehicle and the obstacle candidate object. Although in the present embodiment, different colors are individually used for the overlapping region and the non-overlapping region in the rendering picture VR1 of the present vehicle so as to make different forms, for example, the rendering picture VR1 may be made to significantly differ in brightness between the overlapping region and the non-overlapping region so as to make different forms.

Although the form of the warning line A1 included in the output image shown in FIG. 7 is not particularly limited as long as the left side guide line G1 and the right side guide line G2 can be distinguished from each other, for example, a red line is preferably used. Although the form in which different colors are individually used for the overlapping region and the non-overlapping region in the rendering picture VR1 of the present vehicle is not particularly limited, for example, preferably, a translucent red color is superimposed on the overlapping region in the rendering picture VR1 of the present vehicle, and no color is superimposed on the non-overlapping region in the rendering picture VR1 of the present vehicle. Instead of the warning line A1 and the translucent red color included in the output image shown in FIG. 7, for example, a translucent blue color may be superimposed on the entire non-overlapping region. In this case, the translucent blue color serves as a graphic which indicates the boundary between the overlapping region and the non-overlapping region.

### 2. Second Embodiment

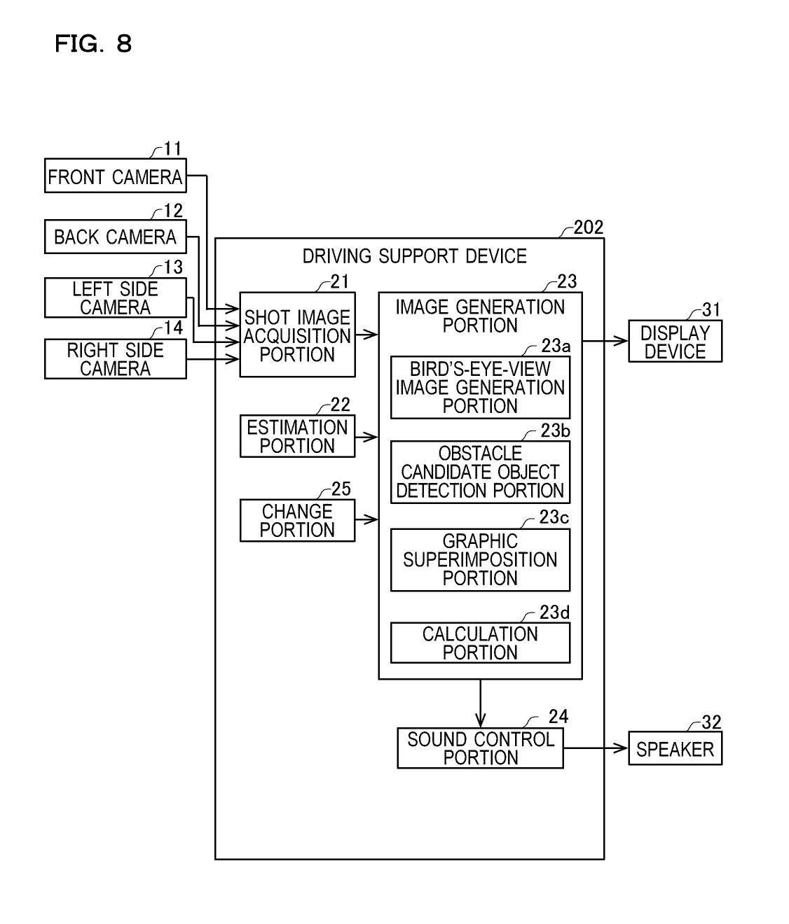

FIG. 8 is a diagram showing the configuration of a driving support device 202 according to the present embodiment. The driving support device 202 differs from the driving support device 201 in that the driving support device 202 includes a change portion 25 and that the image generation portion 23 further includes a calculation portion 23d, and the driving support device 202 is basically the same as the driving support device 201 except the differences described above.

The calculation portion 23d calculates a distance between the present vehicle and the obstacle candidate object based on the shot image of the front camera 11. Although in the present embodiment, the image recognition technology is used so as to calculate the distance between the present vehicle and the obstacle candidate object, in addition to or instead of the image recognition technology, for example, information which is output from a radar device mounted in the present vehicle or information which can be obtained by communication with a cloud center, vehicle-to-vehicle communication road-to-vehicle communication or the like may be used so as to calculate the distance between the present vehicle and the obstacle candidate object.

When the distance between the present vehicle and the obstacle candidate object is more than a predetermined value, even if an overlapping region is present, the graphic superimposition portion 23c does not superimpose a graphic indicating a boundary between the overlapping region and the non-overlapping region on the bird's-eye-view image. In this way, it is possible to prevent the unnecessary appearance of a graphic in a stage where it is hardly necessary for the driver to intuitively grasp the position relationship between the present vehicle and the obstacle candidate object in the vehicle width direction.

When the distance between the present vehicle and the obstacle candidate object is equal to or less than the predetermined value, if an overlapping region is present, the graphic superimposition portion 23c superimposes the graphic indicating the boundary between the overlapping region and the non-overlapping region on the bird's-eye-view image.

The change portion 25 changes the predetermined value described above according to the speed of the present vehicle. For example, the change portion 25 increases the predetermined value as the speed of the present vehicle is increased. In this way, as an anticipated time necessary until the present vehicle and the obstacle candidate object are aligned in the vehicle width direction is shorter, it is possible to make the driver intuitively grasp the position relationship between the present vehicle and the obstacle candidate object in the vehicle width direction in an earlier stage. In this way, it is possible to start to drive while avoiding future contact between the present vehicle and the obstacle candidate object with appropriate timing.

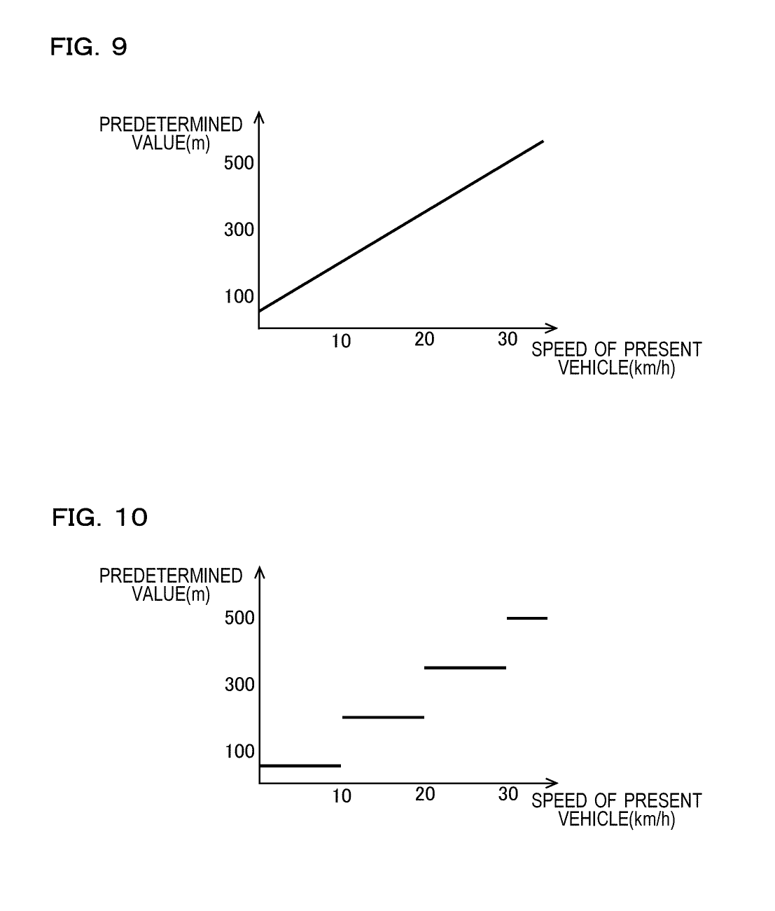

The change portion 25 previously stores, for example, a relationship between the speed of the present vehicle and the predetermined value shown in FIG. 9 in the form of a data table or a relational formula in a nonvolatile manner, acquires the speed information of the present vehicle and the like from the vehicle control ECU and the like of the present vehicle and changes the predetermined value based on the acquired information. The relationship between the speed of the present vehicle and the predetermined value is not limited to the relationship in which the predetermined value is continuously changed with respect to the speed of the present vehicle as shown in FIG. 9, and may be, for example, a relationship in which the predetermined value is not continuously changed with respect to the speed of the present vehicle as shown in FIG. 10.

Unlike the present embodiment, the change portion 25 may change the predetermined value described above according to a relative speed at which the present vehicle approaches the obstacle candidate object. For example, the change portion 25 may increase the predetermined value as the relative speed at which the present vehicle approaches the obstacle candidate object is increased. In this way, the accuracy of a correlation between the anticipated time necessary until the present vehicle and the obstacle candidate object are aligned in the vehicle width direction and the predetermined value is enhanced. The relative speed at which the present vehicle approaches the obstacle candidate object may be calculated by use of the image recognition technology based on the shot image of the front camera 11, and in addition to or instead of the image recognition technology, for example, information which is output from a radar device mounted in the present vehicle or information which can be obtained by communication with a cloud center, vehicle-to-vehicle communication, road-to-vehicle communication or the like may be used so as to calculate the relative speed.

For simplification, unlike the present embodiment, without provision of the change portion 25, the predetermined value described above may be set to a single fixed value.

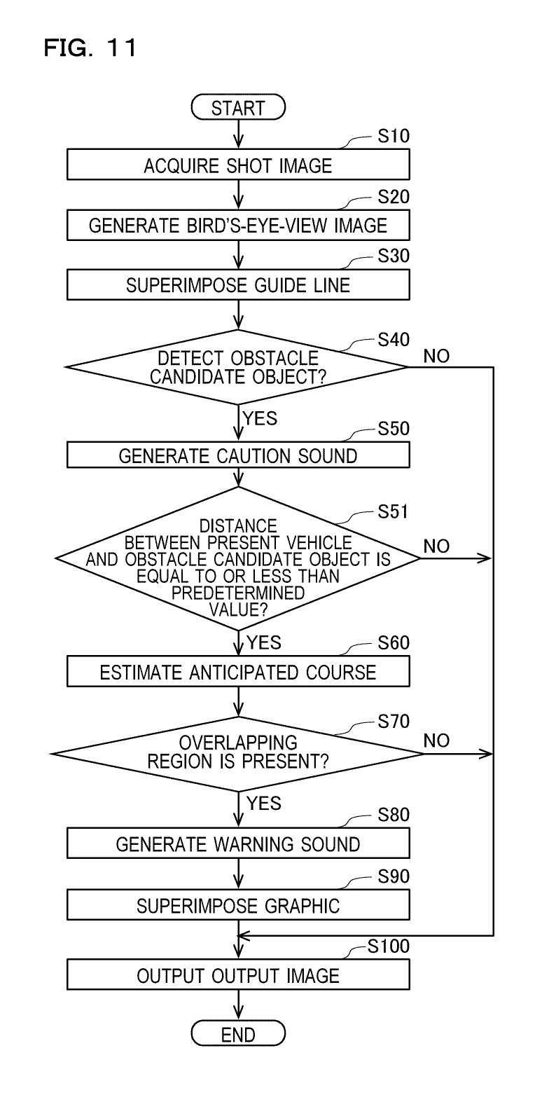

FIG. 11 is a flowchart showing an example of the operation of the driving support device 202. The driving support device 202 periodically performs a flow operation shown in FIG. 11. The flowchart shown in FIG. 11 is obtained by adding step S51 to the flowchart shown in FIG. 4. Step S51 is provided between step S50 and step S60.

In step S51, the calculation portion 23d calculates the distance between the present vehicle and the obstacle candidate object based on the shot image of the front camera 11, and the image generation portion 23 determines whether or not the distance between the present vehicle and the obstacle candidate object is equal to or less than the predetermined value. When the distance between the present vehicle and the obstacle candidate object is equal to or less than the predetermined value, the process is transferred to step S60 whereas when the distance between the present vehicle and the obstacle candidate object is not equal to or less than the predetermined value, the process is transferred to step S100.

### 3. Third Embodiment

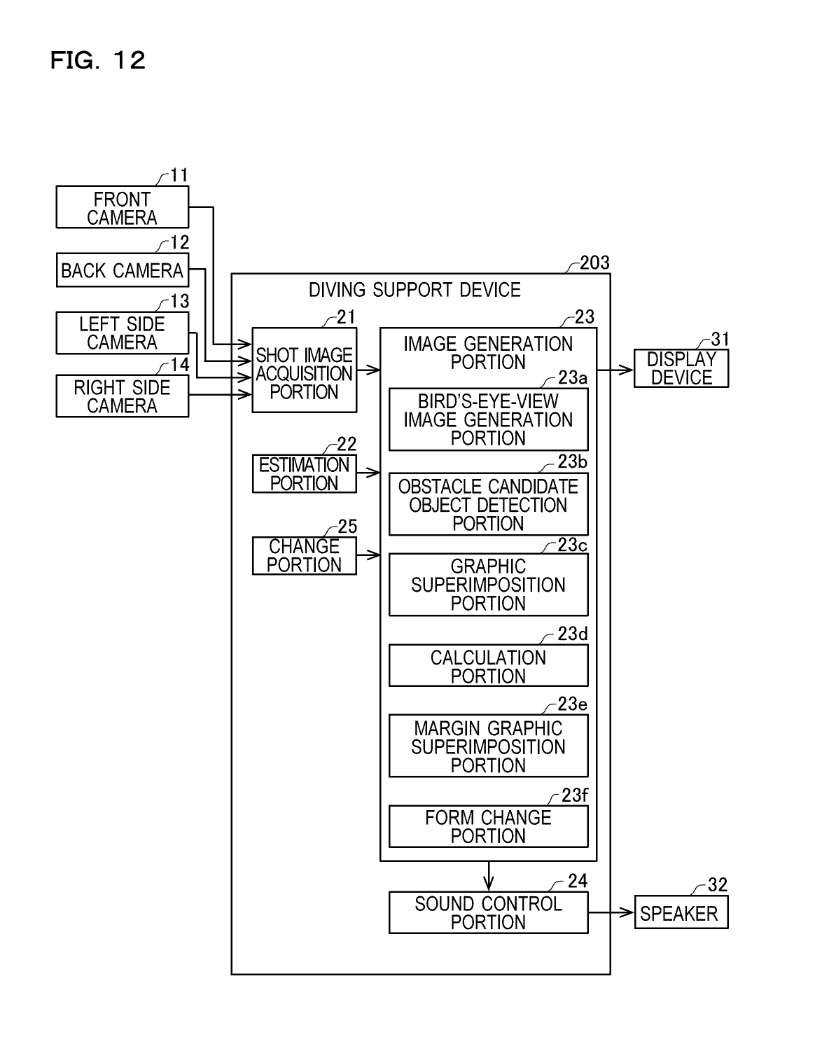

FIG. 12 is a diagram showing the configuration of a driving support device 203 according to the present embodiment. The driving support device 203 differs from the driving support device 202 in that the image generation portion 23 includes a margin graphic superimposition portion 23e and a form change portion 23f, and the driving support device 203 is basically the same as the driving support device 202 except the difference described above.

The margin graphic superimposition portion 23e generates an image including a margin graphic when the overlapping region of the present vehicle and the obstacle candidate object is not present in the vehicle width direction of the anticipated course estimated by the estimation portion 22. The margin graphic shows a region which indicates how far the present vehicle is from the obstacle candidate object in the vehicle width direction of the anticipated course estimated by the estimation portion 22.

The form change portion 23f changes the form of the margin graphic according to the distance between the region occupied by the present vehicle and the region occupied by the obstacle candidate object in the vehicle width direction of the anticipated course estimated by the estimation portion 22. In this way, it is possible to make the driver grasp how high the probability is that an overlapping region of the present vehicle and the obstacle candidate object is produced in the future, and thus the driver can drive with a margin.

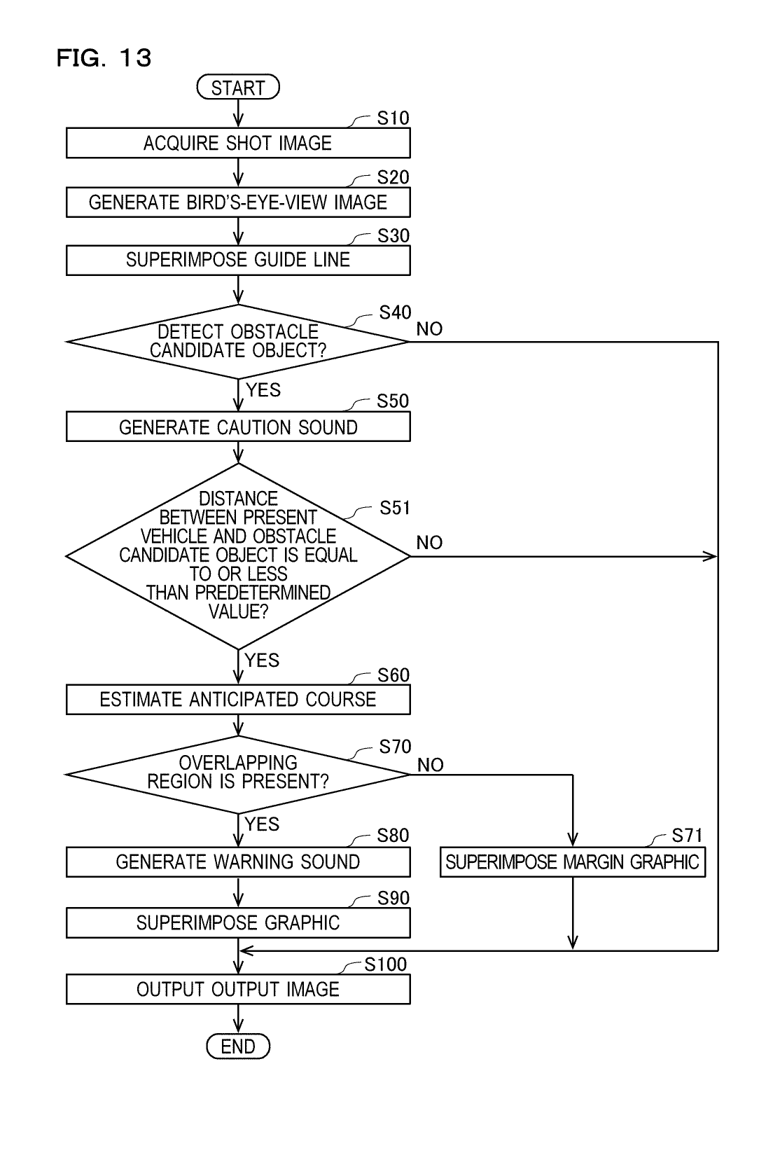

FIG. 13 is a flowchart showing an example of the operation of the driving support device 203. The driving support device 203 periodically performs a flow operation shown in FIG. 13. The flowchart shown in FIG. 13 is obtained by adding step S71 to the flowchart shown in FIG. 11. Unlike the present embodiment, step S51 may be removed from the flowchart shown in FIG. 13.

In the flowchart shown in FIG. 13, when in step S70, it is determined that the overlapping region is not present, the process is transferred to step S71.

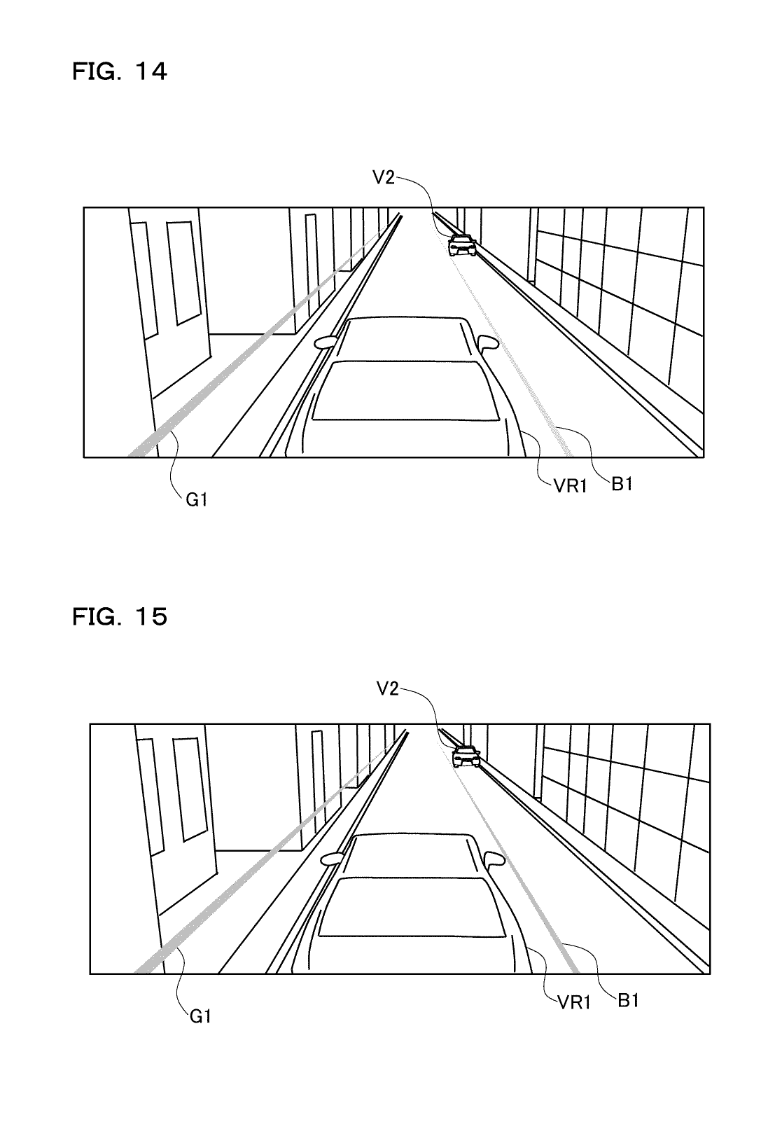

In step S71, the margin graphic superimposition portion 23e generates a margin graphic in a form based on an instruction from the form change portion 23f, and superimposes, instead of the right side guide line, the margin graphic on the bird's-eye-view image, furthermore, in step S100, the image generation portion 23 outputs, as the output image, to the display device 31, a bird's-eye-view image obtained by superimposing, for example, the rendering picture R1 of the present vehicle, the left side guide line G1 and the margin graphic B1 as shown in FIGS. 14 to 16 and the flow operation is completed.

The output image shown in FIG. 14 is an output image when the distance between the region occupied by the present vehicle and the region occupied by the obstacle candidate object in the vehicle width direction of the anticipated course estimated by the estimation portion 22 is more than 0 (m) but equal to or less than a first threshold value TH1 (m), and the margin graphic B1 is set to one yellow line. Since the margin graphic B1 is set yellow, it is easy to find that in the vehicle width direction of the anticipated course estimated by the estimation portion 22, the present vehicle and the obstacle candidate object approach each other.

The output image shown in FIG. 15 is an output image when the distance between the region occupied by the present vehicle and the region occupied by the obstacle candidate object in the vehicle width direction of the anticipated course estimated by the estimation portion 22 is more than the first threshold value TH1 (m) but equal to or less than a second threshold value TH2 (m), and the margin graphic B1 is set to one green line. Since the margin graphic B1 is set green, it is easy to find that in the vehicle width direction of the anticipated course estimated by the estimation portion 22, the present vehicle and the obstacle candidate object are slightly separated from each other.

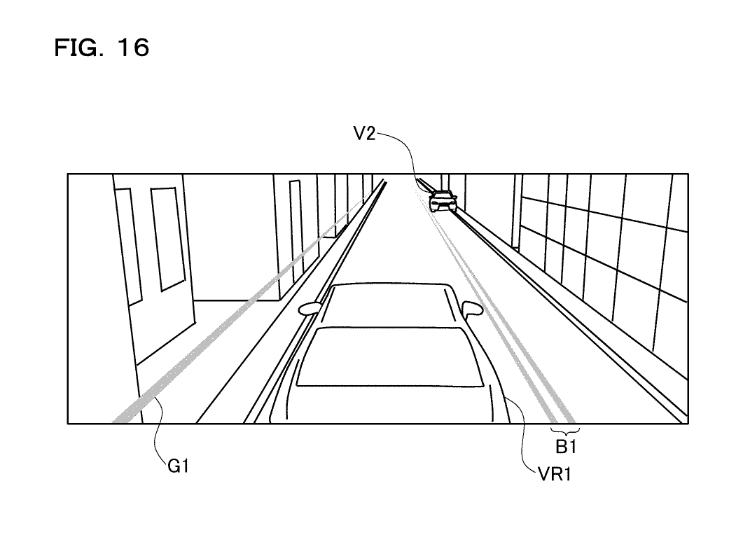

The output image shown in FIG. 16 is an output image when the distance between the region occupied by the present vehicle and the region occupied by the obstacle candidate object in the vehicle width direction of the anticipated course estimated by the estimation portion 22 is more than the second threshold value TH2 (m), and the margin graphic B1 is set to two green lines. Since the margin graphic B1 is set to the two lines, it is easy to find that in the vehicle width direction of the anticipated course estimated by the estimation portion 22, the present vehicle and the obstacle candidate are significantly separated from each other.

Although in the present embodiment, the form change portion 23f changes the form of the margin graphic B1 by the color and the number of lines, for example, the form change portion 23f may change the form of the margin graphic B1 by the thickness and the like of lines.

### 4. Fourth Embodiment

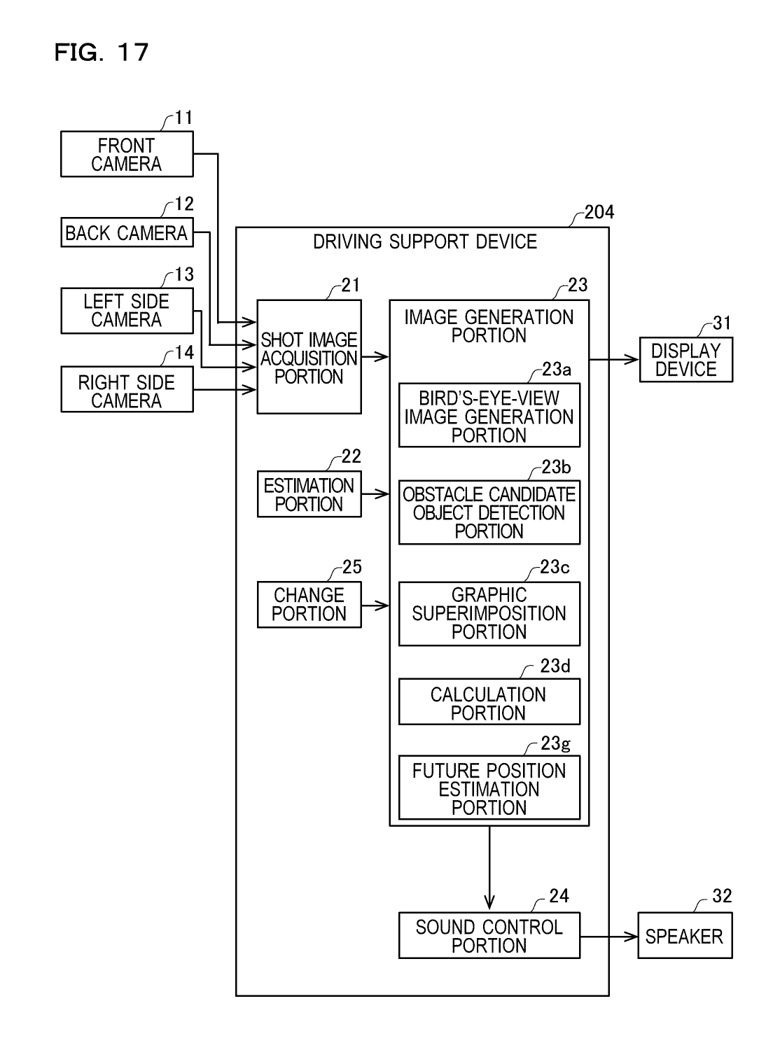

FIG. 17 is a diagram showing the configuration of a driving support device 204 according to the present embodiment. The driving support device 204 differs from the driving support device 202 in that the image generation portion 23 includes a future position estimation portion 23g, and the driving support device 204 is basically the same as the driving support device 202 except the difference described above.

The future position estimation portion 23g estimates the future position of the obstacle candidate object based on the shot image of the front camera 11. In the estimation of the future position of the obstacle candidate object, for example, the background differencing method can be used. Although in the present embodiment, the image recognition technology is used so as to estimate the future position of the obstacle candidate object, in addition to or instead of the image recognition technology, for example, information which is output from a radar device mounted in the present vehicle or information which can be obtained by communication with a cloud center, vehicle-to-vehicle communication, road-to-vehicle communication or the like may be used so as to estimate the future position of the obstacle candidate object.

Then, the image generation portion 23 provides, when a region corresponding to the current position of the obstacle candidate object is not included in the bird's-eye-view image, a picture indicating the obstacle candidate object in a region of the bird's-eye-view image corresponding to the future position of the obstacle candidate object. In this way, even when the region corresponding to the current position of the obstacle candidate object is not present in the bird's-eye-view image including the graphic, it is possible to make the driver intuitively grasp a future position relationship between the present vehicle and the obstacle candidate object. The present embodiment is particularly useful when the vertical width of the display screen of the display device 31 is relatively narrow.

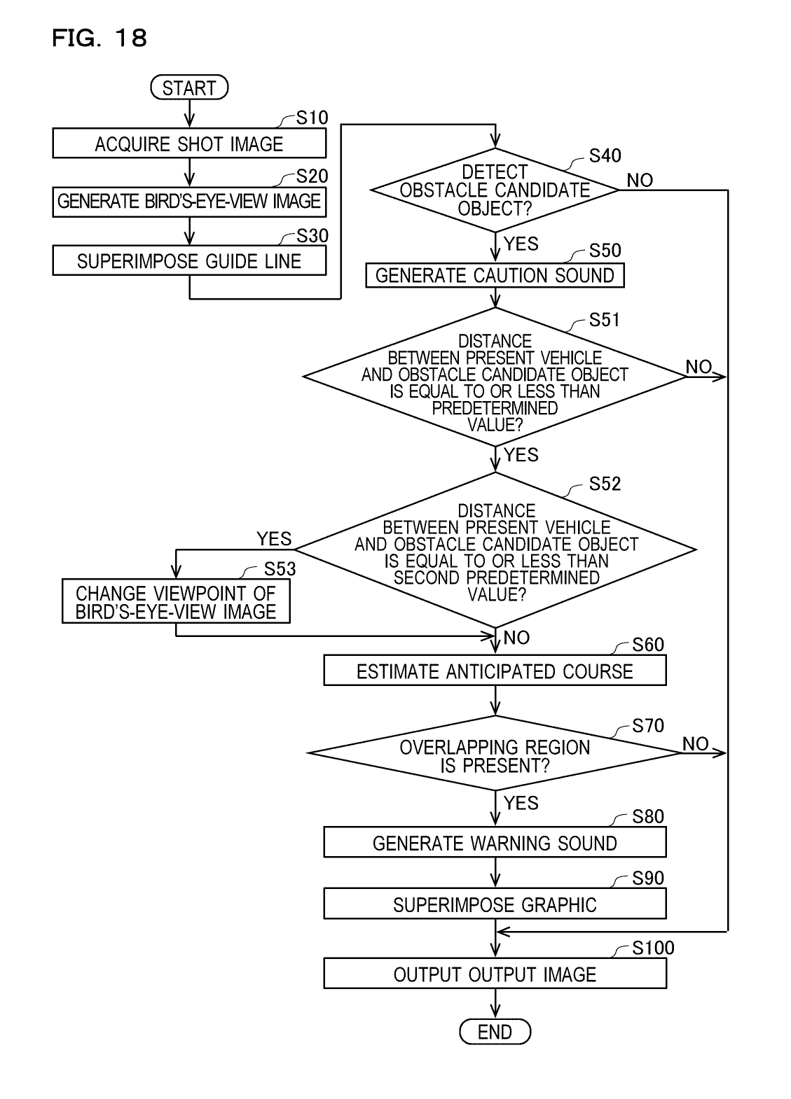

FIG. 18 is a flowchart showing an example of the operation of the driving support device 204. The driving support device 204 periodically performs a flow operation shown in FIG. 18. The flowchart shown in FIG. 18 is obtained by adding step S52 and step S53 to the flowchart shown in FIG. 11.

In the flowchart shown in FIG. 18, when in step S51, it is determined that the distance between the present vehicle and the obstacle candidate object is equal to or less than a predetermined value (first predetermined value), the process is transferred to step S52.

In step S52, the image generation portion 23 determines whether or not the distance between the present vehicle and the obstacle candidate object is equal to or less than a second predetermined value. The second predetermined value is a value which is less than the predetermined value (first predetermined value). As with the predetermined value (first predetermined value), the second predetermined value may be varied according to the speed of the present vehicle or the relative speed at which the present vehicle approaches the obstacle candidate object or may be a single fixed value. Regardless of whether the predetermined value (first predetermined value) is a variable value or a single fixed value, the second predetermined value may be a variable value or a single fixed value.

When the distance between the present vehicle and the obstacle candidate object is equal to or less than the second predetermined value, the process is transferred to step S53 whereas when the distance between the present vehicle and the obstacle candidate object is not equal to or less than the second predetermined value, the process is transferred to step S60.

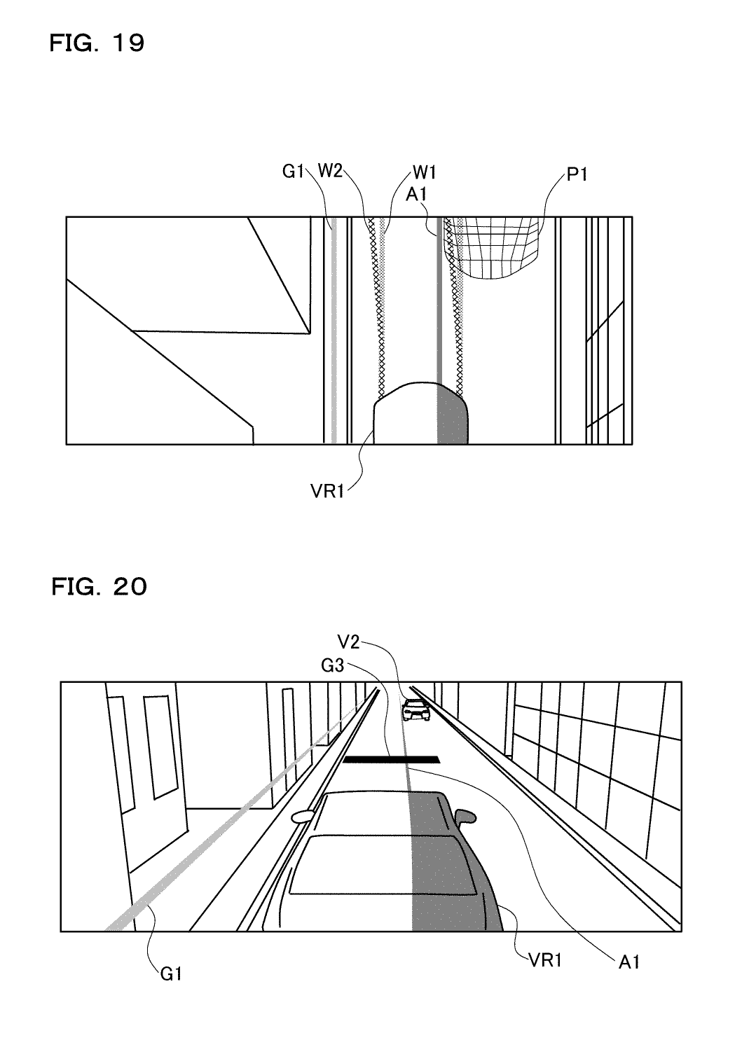

In step S53, the bird's-eye-view image generation portion 23a changes the viewpoint position of the virtual viewpoint to a position immediately above the present vehicle, and changes the view direction of the virtual viewpoint to a direction immediately below the present vehicle (substantially in the direction of gravitational force). When the region corresponding to the current position of the obstacle candidate object is not present in the bird's-eye-view image, the image generation portion 23 provides the picture indicating the obstacle candidate object in the region of the bird's-eye-view image corresponding to the future position of the obstacle candidate object (for example, a polygon picture P1 in FIG. 19 which will be described later and which imitates the obstacle candidate object). Then, when the processing in step S53 is completed, the process is transferred to step S60.

When step S90 is reached through step S53, in step S90, the image generation portion 23 also superimposes, on the bird's-eye-view image, a graphic W1 indicating the anticipated course of the present vehicle at the present time and a graphic W2 indicting a recommended course for avoiding future contact with the obstacle candidate object. Hence, when step S90 is reached through step S53, the output image is, for example, an image as shown in FIG. 19. The graphics W1 and W2 are included in the output image, and thus it is easier for the driver to drive while avoiding future contact between the present vehicle and the obstacle candidate object.

### 5. Others

In addition to the embodiments described above, various variations can be added to various technical features disclosed in the present specification without departing from the split of the technical creation thereof. A plurality of embodiments and variations described in the present specification may be combined and practiced if possible.

For example, when the image generation portion 23 determines that it is impossible to avoid future contact with the obstacle candidate object by the steering of the present vehicle, as shown in FIG. 20, a graphic G3 which indicates a recommended stop position may be superimposed on the bird's-eye-view image. Whether it is impossible to avoid future contact with the obstacle candidate object by the steering of the present vehicle may be determined by use of only the image recognition technology or in addition to or instead of the image recognition technology, for example, information which is output from a radar device mounted in the present vehicle or information which can be obtained by communication with a cloud center, vehicle-to-vehicle communication, road-to-vehicle communication or the like may be used.

For example, when the overlapping region is produced or when the graphic indicating the recommended stop position is superimposed on the bird's-eye-view image, the driving support device may transmit the situation thereof to the vehicle control ECU of the present vehicle such that the vehicle control ECU of the present vehicle performs automatic steering or automatic braking.

Although in the embodiments described above, the output image output by the driving support device is the bird's-eye-view image, the output image output by the driving support device is not limited to the bird's-eye-view image, and for example, a graphic or the like may be superimposed on the shot image of the front camera 11. For example, although even in the shot image of the front camera 11, a slight displacement from the actual position is made, a picture indicating the present vehicle (picture indicating a front end portion of the present vehicle) may be included.

Although in the embodiments described above, the rendering picture VR1 of the present vehicle is superimposed on the bird's-eye-view image, the rendering picture VR1 of the present vehicle does not need to be superimposed on the bird's-eye-view image.

Although in the embodiments described above, the shot image is used for the generation of the output image, CG (Computer Graphics) showing scenery around the present vehicle may be used without use of the shot image so as to generate the output image. When the CG showing the scenery around the present vehicle is used so as to generate the output image, the driving support device preferably acquires the CG showing the scenery around the present vehicle from, for example, a navigation device mounted in the present vehicle.

Since the position relationship between the present vehicle and the obstacle candidate object in the vehicle width direction is important, the scenery around the present vehicle is not necessarily needed. Hence, the scenery around the present vehicle shot by the vehicle-mounted camera and the CG showing the scenery around the present vehicle may be prevented from being included in the output image.

Although in the embodiments described above, the direction in which the present vehicle travels is the forward direction, the present invention can also be applied to a case where the direction in which the present vehicle travels is the backward direction.

In the output image output by the driving support device, the vehicle speed information of the present vehicle, the range information of a shift lever in the present vehicle and the like may be included.

In the third embodiment described above, a configuration may be adopted in which the image generation portion 23 does not include the graphic superimposition portion 23c. In this case, the driving support device preferably performs a flow operation in which steps S80 and S90 are removed from the flowchart shown in FIG. 13.

What is claimed is:

1. A driving support device comprising:
an estimation portion which estimates an anticipated course of a present vehicle; and
an image generation portion which generates an image around the present vehicle including a graphic,
wherein the graphic at least indicates, in a vehicle width direction of the anticipated course, part of an edge of a region occupied by an obstacle candidate object that is present in a direction in which the present vehicle travels.

2. The driving support device according to claim 1,
wherein the graphic further indicates, in the vehicle width direction of the anticipated course, an overlapping region of a region occupied by the present vehicle and the region occupied by the obstacle candidate object that is present in the direction in which the present vehicle travels.

3. The driving support device according to claim 1,
wherein the graphic further indicates, in the vehicle width direction of the anticipated course, a region representing a margin which is a distance between a region occupied by the present vehicle and the region occupied by the obstacle candidate object that is present in the direction in which the present vehicle travels.

4. The driving support device according to claim 3, further comprising:
a form change portion,
wherein the form change portion changes a form of the graphic according to the margin.

5. The driving support device according to claim 1,
wherein the image generation portion generates an image which includes the graphic and a picture indicating the present vehicle.

6. The driving support device according to claim 5,
wherein the graphic further indicates, in the vehicle width direction of the anticipated course, an overlapping region of a region occupied by the present vehicle and the region occupied by the obstacle candidate object that is present in the direction in which the present vehicle travels, and
the image generation portion displays the overlapping region of the picture indicating the present vehicle in the image in a form different from regions other than the overlapping region.

7. The driving support device according to claim 1, further comprising:
a calculation portion which calculates a distance between the present vehicle and the obstacle candidate object,
wherein when the distance is more than a predetermined value, the image generation portion generates an image which does not include the graphic whereas when the distance is equal to or less than the predetermined value, the image generation portion generates the image which includes the graphic.

8. The driving support device according to claim 7, further comprising:
a change portion which changes the predetermined value according to a speed of the present vehicle.

9. The driving support device according to claim 8,
wherein the change portion increases the predetermined value as the speed is increased.

10. The driving support device according to claim 7, further comprising:
a change portion that changes the predetermined value according to a relative speed at which the present vehicle approaches the obstacle candidate object.

11. The driving support device according to claim 10,
wherein the change portion increases the predetermined value as the relative speed is increased.

12. The driving support device according to claim 1, further comprising:
a future position estimation portion which estimates a future position of the obstacle candidate object,
wherein when a region corresponding to a current position of the obstacle candidate object is not included in the image including the graphic, the image generation portion provides a picture indicating the obstacle candidate object in a region of the image including the graphic corresponding to the future position.

13. A driving support method comprising:
an estimation step of estimating an anticipated course of a present vehicle; and
an image generation step of generating an image around the present vehicle including a graphic,
wherein the graphic at least indicates, in a vehicle width direction of the anticipated course, part of an edge of a region occupied by an obstacle candidate object that is present in a direction in which the present vehicle travels.
